(19) United States
(12) Patent Application Publication
(10) Pub. No.: US 2024/0138554 A1
(43) Pub. Date: May 2, 2024

(54) APPLICATOR, CONTAINER INCLUDING SAME, AND MOLD FOR MANUFACTURING SAME

(71) Applicant: SHYA HSIN PACKAGING INDUSTRY (CHINA) CO., LTD., Kunshan (CN)

(72) Inventors: Christophe Jacob, Kunshan (CN); Fuhai YU, Kunshan (CN)

(73) Assignee: SHYA HSIN PACKAGING INDUSTRY (CHINA) CO., LTD., Kunshan (CN)

(21) Appl. No.: 18/138,753

(22) Filed: Apr. 25, 2023

(30) Foreign Application Priority Data
Oct. 31, 2022 (CN) 202211346092.X

(51) Int. Cl. A46B 9/02; A45D 40/26; A46B 11/00; B29C 45/26

(52) U.S. Cl. CPC A46B 9/021; A45D 40/264; A45D 40/265; A46B 11/0041; A46B 11/0062; B29C 45/2626; A46B 2200/1046; B29L 2031/42

(57) ABSTRACT

An applicator, a container including the applicator, and a mold for manufacturing the applicator are provided. The applicator includes a mounting portion and an application portion that are connected to each other. The application portion is provided with a first surface and a second surface that are opposite to each other. Bristles are arranged on the first surface. A recessed portion is provided on the application portion. The recessed portion communicates with the first surface, and the recessed portion is protruded from the second surface. The recessed portion is provided in the applicator. When the recessed portion passes through an inner plug, the inner plug squeezes the recessed portion, such that the cosmetic in the recessed portion flows to the bristles, and the bristles carry a large amount of the cosmetic when pulled out of the bottle.

### CROSS REFERENCE TO THE RELATED APPLICATIONS

This application is based upon and claims priority to Chinese Patent Application No. 202211346092.X, filed on Oct. 31, 2022, the entire contents of which are incorporated herein by reference.

### TECHNICAL FIELD

The present application relates to an application device, and in particular to an applicator, a container including the applicator, and a mold for manufacturing the applicator.

### BACKGROUND

When a common applicator such as a lash brush or an eyebrow brush is pulled out of a cosmetic bottle, an inner plug scrapes a large amount of the cosmetic, while an application head can only carry a small amount of the cosmetic. When more cosmetic is required, the user needs to dip the cosmetic frequently for makeup. This is inconvenient and inefficient.

### SUMMARY

The present application provides an applicator to overcome the above-mentioned defects. A recessed portion is provided in the applicator. When the recessed portion passes through an inner plug, the inner plug squeezes the recessed portion, such that the cosmetic in the recessed portion flows to the bristles, and the bristles carry a large amount of the cosmetic when pulled out of the bottle. Therefore, the present application increases a volume of the applicator to dip the cosmetic at a time and makes a user dip the cosmetic less frequently in makeup.

To solve the technical problems, the present application employs the following technical solutions.

An applicator includes a mounting portion and an application portion that are connected to each other, where the application portion is provided with a first surface and a second surface that are opposite to each other; bristles are arranged on the first surface; a recessed portion is provided on the application portion; and the recessed portion communicates with the first surface, and the recessed portion is protruded from the second surface.

Optionally, the recessed portion is provided with a third surface and a fourth surface; the third surface and the first surface are located at a same side of the applicator; the fourth surface and the second surface are located at a same side of the applicator; and the bristles are arranged on the third surface.

Optionally, the recessed portion extends along a length direction of the application portion, and the recessed portion is located at a central position of the application portion.

Optionally, a length of the recessed portion is defined as L1, a length of the application portion is defined as L2, and 0.5*L2≤L1<L2; and a width of the recessed portion is defined as B1, a width of the application portion is defined as B2, and 0.5*B2≤B1<B2.

Optionally, a periphery of the recessed portion is fixedly connected to the application portion.

Optionally, a cross section of the recessed portion along a width direction is “V”-shaped or “U”-shaped, and the bristles are arranged on the fourth surface of the recessed portion.

Optionally, at least a part of regions in the periphery of the recessed portion is disconnected from the application portion.

Optionally, the application portion is a curved structure; the first surface is a convex surface; the second surface is a concave surface; roots of the bristles are fixedly connected to the first surface of the application portion; and heads of the bristles extend toward a direction away from the second surface, and the heads of the bristles are free ends.

The present application further provides a container, including the above-mentioned applicator, a bottle, an inner plug, and a lid component, where the mounting portion of the applicator is fixedly connected to the lid component; the applicator is provided in the bottle, and the lid component covers the bottle; and the inner plug is provided at an open end of the bottle.

The present application further provides a mold for manufacturing the above-mentioned applicator.

The present application has the following beneficial effects: The applicator includes a mounting portion and an application portion. A recessed portion and bristles are arranged on the application portion. The recessed portion communicates with the bristles on the application portion. When the application portion is immersed in the bottle, the recessed portion can store a certain amount of the cosmetic. When the application portion is pulled out, and the recessed portion passes through the inner plug, the inner plug squeezes the recessed portion to cause a deformation of the recessed portion. The cosmetic in the recessed portion flows to the bristles, and the bristles carry a large amount of the cosmetic when pulled out of the bottle. Therefore, the present application increases a volume of the applicator to dip the cosmetic at a time, makes a user dip the cosmetic less frequently, yields a higher makeup efficiency, and meets a makeup requirement on the large amount of the cosmetic in use. With the recessed portion at a central position of the application portion, the present application can meet the requirement on the amount of the cosmetic, without affecting a makeup effect. Moreover, the overall structure of the applicator is aesthetically pleasing and high-end.

### BRIEF DESCRIPTION OF THE DRAWINGS

FIG. 1 is a first stereoscopic view of an applicator according to Embodiment 1 of the present application;

FIG. 2 is a second stereoscopic view of an applicator according to Embodiment 1 of the present application;

FIG. 3 is a front view of an applicator according to Embodiment 1 of the present application;

FIG. 4 is a left view of an applicator according to Embodiment 1 of the present application;

FIG. 5 is a right view of an applicator according to Embodiment 1 of the present application;

FIG. 6 is a bottom view of an applicator according to Embodiment 1 of the present application;

FIG. 7 is a top view of an applicator according to Embodiment 1 of the present application;

FIG. 8 is a sectional view of an applicator according to Embodiment 1 of the present application;

FIG. 9 is a first stereoscopic view of an applicator according to Embodiment 2 of the present application;

FIG. 10 is a second stereoscopic view of an applicator according to Embodiment 2 of the present application;

FIG. 11 is a front view of an applicator according to Embodiment 2 of the present application;

FIG. 12 is a left view of an applicator according to Embodiment 2 of the present application;

FIG. 13 is a right view of an applicator according to Embodiment 2 of the present application;

FIG. 14 is a bottom view of an applicator according to Embodiment 2 of the present application;

FIG. 15 is a top view of an applicator according to Embodiment 2 of the present application;

FIG. 16 is a sectional view of an applicator according to Embodiment 2 of the present application;

FIG. 17 is a first stereoscopic view of an applicator according to Embodiment 3 of the present application;

FIG. 18 is a second stereoscopic view of an applicator according to Embodiment 3 of the present application;

FIG. 19 is a front view of an applicator according to Embodiment 3 of the present application;

FIG. 20 is a left view of an applicator according to Embodiment 3 of the present application;

FIG. 21 is a right view of an applicator according to Embodiment 3 of the present application;

FIG. 22 is a bottom view of an applicator according to Embodiment 3 of the present application;

FIG. 23 is a top view of an applicator according to Embodiment 3 of the present application; and

FIG. 24 is a sectional view of an applicator according to Embodiment 3 of the present application.

In the figures: 10—mounting portion, 20—application portion, 21—first surface, 22—second surface, 23—bristle, 30—recessed portion, 31—third surface, and 32—fourth surface.

### DETAILED DESCRIPTION OF THE EMBODIMENTS

The technical solutions in the embodiments of the present application are clearly and completely described below with reference to the embodiments of the present application. Apparently, the described embodiments are merely some rather than all of the embodiments of the present application. All other embodiments obtained by those of ordinary skill in the art based on the embodiments of the present application without creative efforts should fall within the protection scope of the present application.

It should be noted that the terms “first”, “second”, and so on in the description and claims of this application and in the above accompanying drawings are intended to distinguish similar objects but do not necessarily indicate a specific order or sequence. It should be understood that the objects used in such a way may be exchanged under proper conditions to make it possible to implement the described implementations of this application in sequences except those illustrated or described herein. Moreover, the terms “include”, “have” and their variants mean to cover a non-exclusive inclusion. For example, a process, method, system, product or device that includes a list of steps or units is not necessarily limited to those steps or units which are clearly listed. Instead, they may include other steps or units which are not expressly listed or inherent to such a process, method, product, or device.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

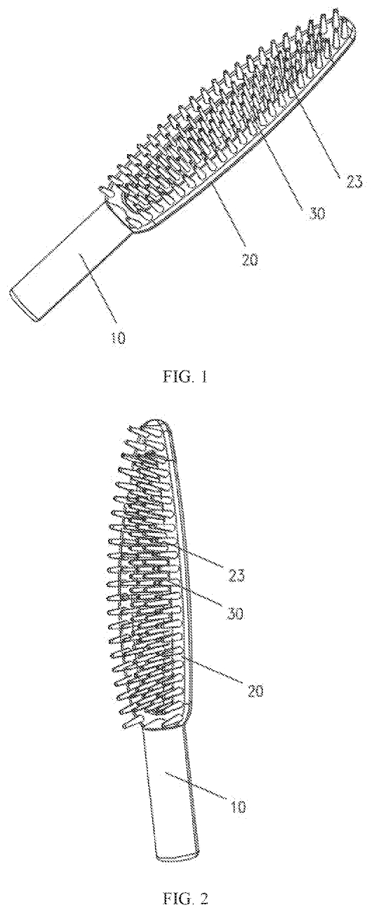

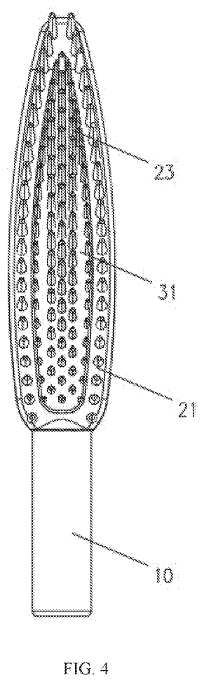

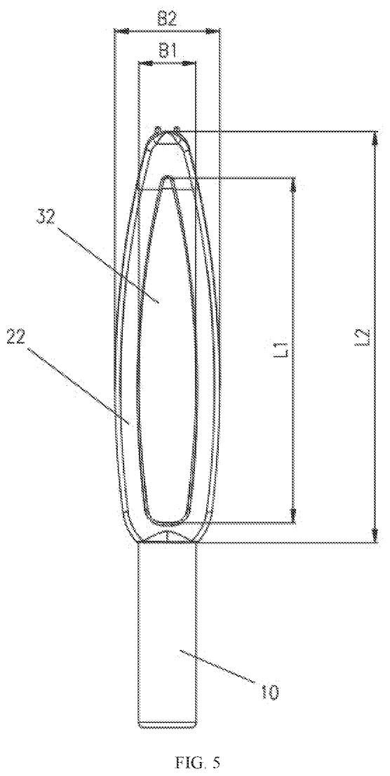

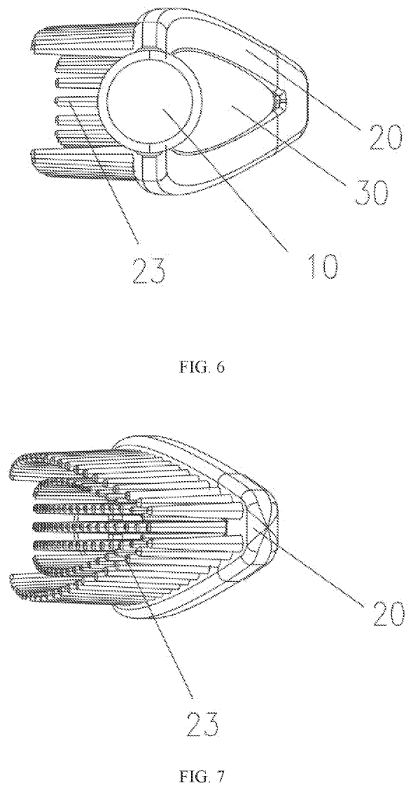

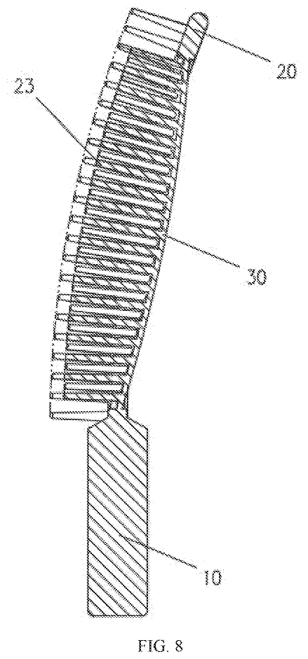

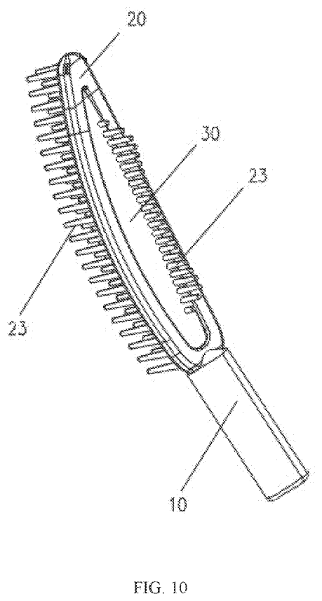

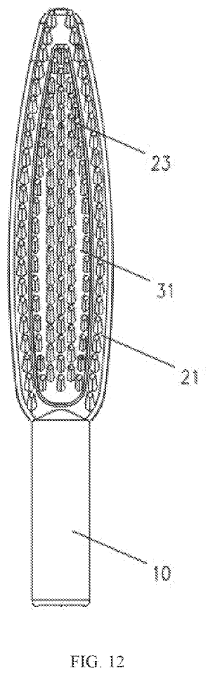

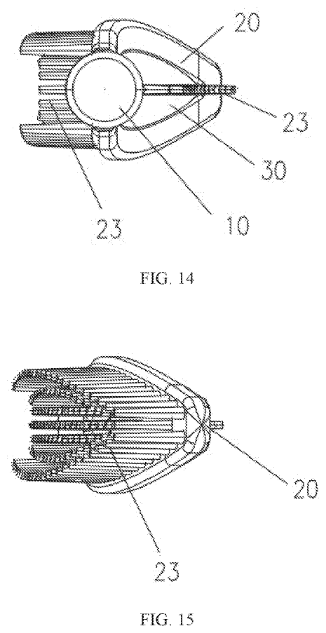

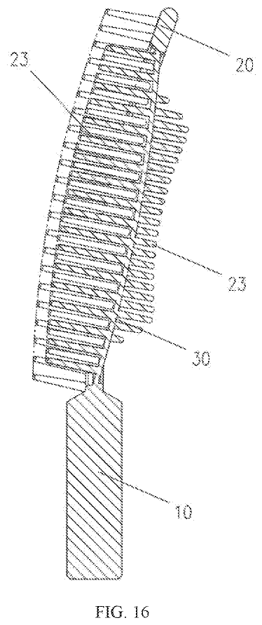

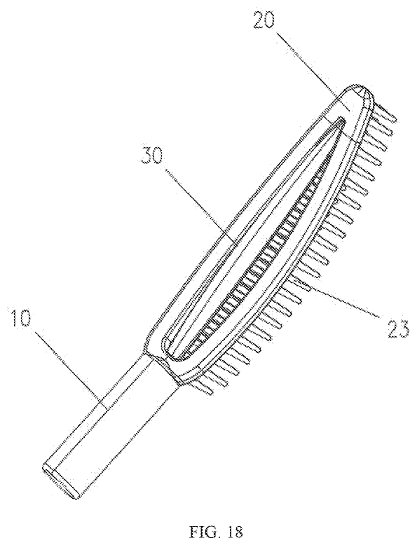

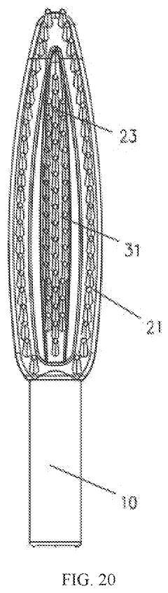

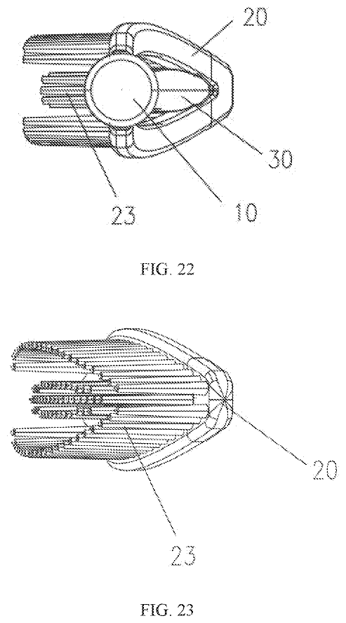

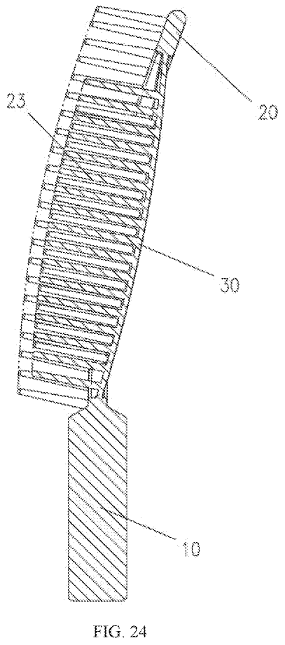

As shown in FIGS. 1-24, an applicator includes mounting portion 10 and application portion 20 that are connected to each other. The application portion 20 is provided with first surface 21 and second surface 22 that are opposite to each other. Bristles 23 are arranged on the first surface 21. Recessed portion 30 is provided on the application portion 20. The recessed portion 30 communicates with the first surface 21, and the recessed portion 30 is protruded from the second surface 22. In the present application, the mounting portion 10 and the application portion 20 are fixedly connected. The mounting portion 10 and the application portion 20 may be an integrally-formed injection molded piece, and may also be independently subjected to injection molding and then assembled together. In a possible implementation, the applicator may be assembled on a brush rod through the mounting portion 10. The application portion 20 is provided with a frontside and a backside. For convenience of subsequent description, the frontside of the application portion 20 is referred to as the first surface 21. The backside of the application portion 20 is referred to as the second surface 22. The whole application portion 20 may be a flat structure, and may also be a curved structure. When the whole application portion 20 is a flat surface, both the first surface 21 and the second surface 22 are a flat surface. When the whole application portion 20 is a curved surface, the first surface 21 is a flat surface, while the second surface 22 is a convex surface or a concave surface. Or the first surface 21 is a convex surface or a concave surface, while the second surface 22 is a flat surface. Or the first surface 21 is a convex surface, while the second surface 22 is a concave surface. Or the first surface 21 is a concave surface, while the second surface 22 is a convex surface. Or both the first surface 21 and the second surface 22 are a concave surface or a convex surface. Regardless of the structure of the application portion 20, the bristles 23 are always arranged on the first surface 21. The recessed portion 30 is protruded from the second surface 22. A groove is formed in the recessed portion 30 to store a cosmetic. When the application portion 20 is immersed in the bottle, the groove of the recessed portion 30 can store a certain amount of the cosmetic. When the application portion 20 is pulled out, and the recessed portion 30 passes through the inner plug, the inner plug squeezes the recessed portion 30 to cause a deformation of the recessed portion. The cosmetic in the recessed portion 30 flows to the bristles 23 on the first surface 21, and the bristles carry a large amount of the cosmetic when pulled out of the bottle. Therefore, the present application increases a volume of the applicator to dip the cosmetic at a time, makes a user dip the cosmetic less frequently, and yields a higher makeup efficiency.

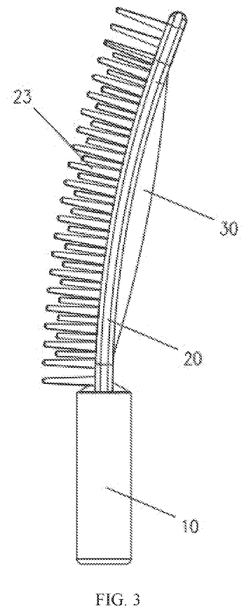

As shown in FIGS. 3-5, the recessed portion 30 is provided with third surface 31 and fourth surface 32. The third surface 31 and the first surface 21 are located at a same side of the applicator. The fourth surface 32 and the second surface 22 are located at a same side of the applicator. The bristles 23 are arranged on the third surface 31. The recessed portion 30 is also provided with a frontside and a backside. The frontside of the recessed portion 30 is referred to as the third surface 31. The backside of the recessed portion 30 is referred to as the fourth surface. The first surface 21 and the third surface 31 are respectively provided with the bristles 23 to form a working surface. The second surface 22 is a non-working surface. The fourth surface 32 may be designed as a working surface, and may also be designed as a non-working surface, which will be described below in detail.

As shown in FIGS. 1-5, the recessed portion 30 extends along a length direction of the application portion 20. The recessed portion 30 is located at a central position of the application portion 20. The application portion 20 includes a first end connected to the mounting portion 10, and a second end serving as a free end. The direction of the application portion 20 from the first end to the second end is defined as the length direction of the application portion. A distance from the first end to the second end serves as a length of the application portion 20. The width direction of the application portion 20 is a direction perpendicular to the length direction. The width of the application portion 20 refers to a maximum distance in the width direction of the application portion. The length and the width of the recessed portion 30 are also defined in a same way. The recessed portion 30 is located at the central position of the application portion 20, which means that central lines of the recessed portion 30 and the application portion 20 along the length directions and along the width directions coincide with each other. Certainly, a plurality of the recessed portions 30 may also be provided on the application portion 20. The recessed portions 30 may be arranged along the length direction of the application portion 20, and may also be arranged along the width direction of the application portion 20. When there is one recessed portion 30 on the application portion 20, the recessed portion may also be provided at a noncentral position of the application portion. The lengths and widths of the bristles 23, distances between adjacent bristles, and arrangements of the bristles 23 may be determined according to an actual requirement in use. Optionally, the bristles 23 on the third surface 31 are lower than the bristles 23 on the first surface 21. A density of the bristles 23 on the third surface is greater than a density of the bristles on the first surface 21. The bristles 23 are uniformly arranged on the first surface 21 and the third surface 31.

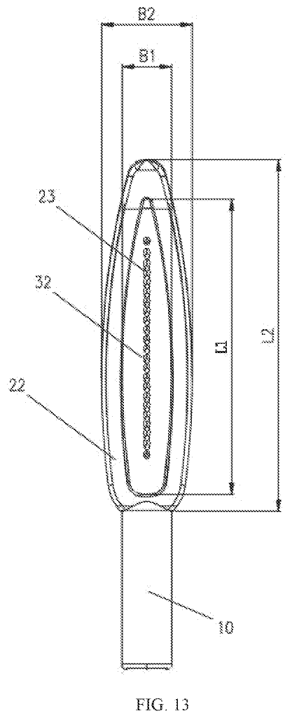

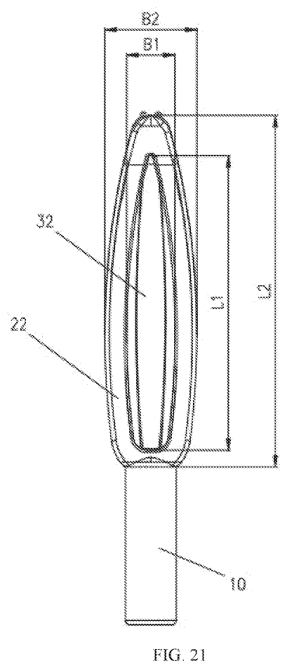

As shown in FIG. 5, FIG. 13 and FIG. 21, a length of the recessed portion 30 is defined as L1, a length of the application portion 20 is defined as L2, and 0.5*L2≤L1<L2. A width of the recessed portion 30 is defined as B1, a width of the application portion 20 is defined as B2, and 0.5*B2≤B1<B2. According to experimental verification, by providing the recessed portion 30 at the central position of the application portion 20, and defining the length and the width of the recessed portion within the above ranges, the applicator can meet the requirement on the amount of the cosmetic, without affecting a makeup effect. Moreover, the overall structure of the applicator is aesthetically pleasing and high-end.

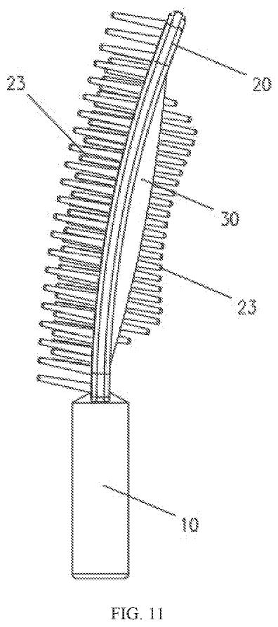

As shown in FIG. 3 and FIG. 11, a periphery of the recessed portion 30 is fixedly connected to the application portion 20. The whole central part of the application portion 20 is collapsed toward the backside. The collapsed region is the recessed portion 30. Hence, a space between the recessed portion 30 and the application portion 20 is sealed. The groove, which is opened at an upper end and sealed in a periphery, is formed in the recessed portion 30 to store the cosmetic.

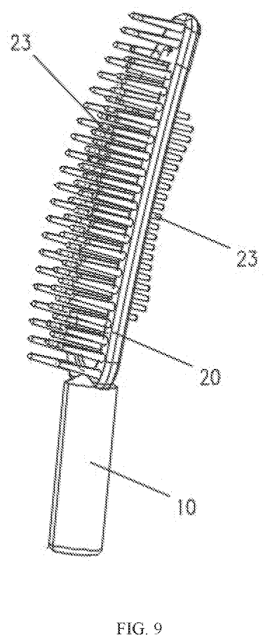

A cross section of the recessed portion 30 along a width direction is “V”-shaped or “U”-shaped. The bristles 23 are arranged on the fourth surface 32 of the recessed portion 30. Embodiment 1: As shown in FIGS. 1-8, the cross section of the recessed portion 30 along the width direction is “V”-shaped, namely a very narrow ridge is provided at a highest place of the fourth surface 32 of the recessed portion 30. The ridge can be taken as a scraper for use in makeup. The cross section of the recessed portion 30 along the width direction may also be “U”-shaped, namely the recessed portion 30 is a curved surface, the third surface 31 is a concave surface, and the fourth surface 32 is a convex surface, thereby storing a large amount of the cosmetic. Certainly, the cross section of the recessed portion 30 along the width direction may also be other conventional shapes such as an inverted “omega”-shape and “right-angled-U” shape. Embodiment 2: Optionally, as shown in FIGS. 9-16, a row of short bristles 23 is arranged on the ridge of the recessed portion 30 for fine makeup.

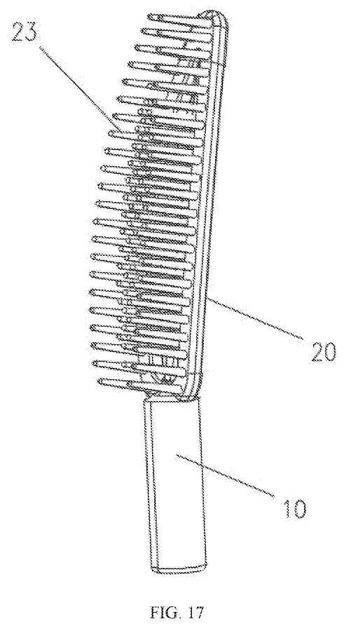

Embodiment 3: As shown in FIGS. 17-24, at least a part of regions in the periphery of the recessed portion 30 is disconnected from the application portion 20. The whole recessed portion 30 is protruded toward the second surface 22, and at least a part of regions of the recessed portion 30 is separated from the application portion 20. Optionally, only front and rear ends of the recessed portion 30 along the length direction are connected to the application portion 20, while the remaining regions are disconnected from the application portion 20, namely the recessed portion 30 forms a connecting bridge. With such a structure of the recessed portion 30, the recessed portion has a higher elasticity, while less requirements are imposed on the elasticity of the applicator to select the material of the applicator in a wider range. Optionally, the recessed portion 30 is a strip-shaped structure. The bristles 23 are arranged on the fourth surface 32 of the recessed portion. Therefore, the specific shape of the recessed portion 30 can be determined according to the material and actual requirement of the applicator.

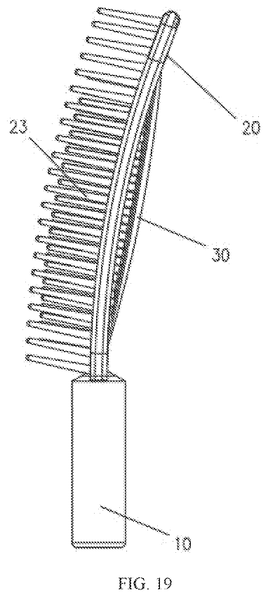

As shown in FIG. 3, FIG. 11 and FIG. 19, the application portion 20 is a curved structure. The first surface 21 is a convex surface. The second surface 22 is a concave surface. Roots of the bristles 23 are fixedly connected to the first surface 21 of the application portion 20. Heads of the bristles 23 extend toward a direction away from the second surface 22, and the heads of the bristles 23 are free ends. The whole application portion 20 is protruded toward the first surface 21. The bristles 23 are arranged on the first surface 21, namely the bristles 23 are arranged on the convex surface. Such a structure facilitates the makeup, and meets makeup habits of the user. However, in the structure, the bristles carry a little cosmetic. In view of this, the recessed portion 30 protruded toward the second surface 22 is provided on the application portion 20, namely the protruded direction of the application portion 20 is reversed to the protruded direction of the recessed portion 30. When the applicator is pulled out of the bottle, the recessed portion 30 can carry a part of the cosmetic to supply to the bristles.

The present application further provides a container. The container includes the above-mentioned applicator, a bottle, an inner plug, and a lid component. The mounting portion 10 of the applicator is fixedly connected to the lid component. The applicator is provided in the bottle, and the lid component covers the bottle. The inner plug is provided at an open end of the bottle. In a possible implementation, the lid component further includes a brush rod. When the applicator is used, the lid component is screwed off, and the applicator is pulled out of the bottle. When the application portion 20 is immersed in the bottle, the bristles 23 are covered by the cosmetic, and the recessed portion 30 also stores a certain amount of the cosmetic. When the application portion 20 is pulled out, most of the cosmetic on the bristles 23 is squeezed out by the inner plug, and the inner plug squeezes the recessed portion 30 to cause a deformation of the recessed portion. The cosmetic in the recessed portion 30 flows to the bristles 23, the bristles carry a large amount of the cosmetic when pulled out of the bottle, and the recessed portion 30 also carries a part of the cosmetic. Therefore, the present application increases a volume of the applicator to dip the cosmetic at a time.

The present application further provides a mold for manufacturing the above-mentioned applicator. The applicator can be formed at a time through the mold, namely the applicator is an integrally-formed injection molded part. Or the mounting portion 10 and the application portion 20 in the applicator can be formed into two independent injection molded parts through the mold, and then assembled together to form the applicator.

Optionally, there are a plurality of the molds. Each mold is configured to manufacture one component of the applicator through injection molding. Each component is combined by means of assembly, pasting, ultrasonic bonding, and so on.

It should be noted that those of ordinary skill in the art can further make variations and improvements without departing from the conception of the present application. These variations and improvements all fall within the protection scope of the present application. Therefore, the protection scope of the present application should be subject to the protection scope defined by the claims.

What is claimed is:

1. An applicator, comprising a mounting portion and an application portion, wherein the mounting portion and the application portion are connected to each other, and the application portion is provided with a first surface and a second surface, wherein the first surface and the second surface are opposite to each other; bristles are arranged on the first surface; a recessed portion is provided on the application portion; and the recessed portion communicates with the first surface, and the recessed portion is protruded from the second surface.

2. The applicator according to claim 1, wherein the recessed portion is provided with a third surface and a fourth surface; the third surface and the first surface are located at a first side of the applicator; the fourth surface and the second surface are located at a second side of the applicator; and the bristles are arranged on the third surface.

3. The applicator according to claim 2, wherein the recessed portion extends along a length direction of the application portion, and the recessed portion is located at a central position of the application portion.

4. The applicator according to claim 3, wherein a length of the recessed portion is defined as L1, a length of the application portion is defined as L2, and 0.5*L2≤L1<L2; and a width of the recessed portion is defined as B1, a width of the application portion is defined as B2, and 0.5*B2≤B1<B2.

5. The applicator according to claim 3, wherein a periphery of the recessed portion is fixedly connected to the application portion.

6. The applicator according to claim 5, wherein a cross section of the recessed portion along a width direction is V-shaped or U-shaped, and the bristles are arranged on the fourth surface of the recessed portion.

7. The applicator according to claim 3, wherein at least a part of regions in a periphery of the recessed portion is disconnected from the application portion.

8. The applicator according to claim 1, wherein the application portion is a curved structure; the first surface is a convex surface; the second surface is a concave surface; roots of the bristles are fixedly connected to the first surface of the application portion; and heads of the bristles extend toward a direction away from the second surface, and the heads of the bristles are free ends.

9. A container, comprising the applicator according to claim 1, a bottle, an inner plug, and a lid component, wherein the mounting portion of the applicator is fixedly connected to the lid component; the applicator is provided in the bottle, and the lid component covers the bottle; and the inner plug is provided at an open end of the bottle.

10. A mold for manufacturing the applicator according to claim 1.

11. The container according to claim 9, wherein in the applicator, the recessed portion is provided with a third surface and a fourth surface; the third surface and the first surface are located at a first side of the applicator; the fourth surface and the second surface are located at a second side of the applicator; and the bristles are arranged on the third surface.

12. The container according to claim 11, wherein in the applicator, the recessed portion extends along a length direction of the application portion, and the recessed portion is located at a central position of the application portion.

13. The container according to claim 12, wherein in the applicator, a length of the recessed portion is defined as L1, a length of the application portion is defined as L2, and 0.5*L2≤L1<L2; and a width of the recessed portion is defined as B1, a width of the application portion is defined as B2, and 0.5*B2≤B1<B2.

14. The container according to claim 12, wherein in the applicator, a periphery of the recessed portion is fixedly connected to the application portion.

15. The container according to claim 14, wherein in the applicator, a cross section of the recessed portion along a width direction is V-shaped or U-shaped, and the bristles are arranged on the fourth surface of the recessed portion.

16. The container according to claim 12, wherein in the applicator, at least a part of regions in a periphery of the recessed portion is disconnected from the application portion.

17. The container according to claim 9, wherein in the applicator, the application portion is a curved structure; the first surface is a convex surface; the second surface is a concave surface; roots of the bristles are fixedly connected to the first surface of the application portion; and heads of the bristles extend toward a direction away from the second surface, and the heads of the bristles are free ends.

18. The mold according to claim 10, wherein in the applicator, the recessed portion is provided with a third surface and a fourth surface; the third surface and the first surface are located at a first side of the applicator; the fourth surface and the second surface are located at a second side of the applicator; and the bristles are arranged on the third surface.

19. The mold according to claim 18, wherein in the applicator, the recessed portion extends along a length direction of the application portion, and the recessed portion is located at a central position of the application portion.

20. The mold according to claim 19, wherein in the applicator, a length of the recessed portion is defined as L1, a length of the application portion is defined as L2, and 0.5*L2≤L1<L2; and a width of the recessed portion is defined as B1, a width of the application portion is defined as B2, and 0.5*B2≤B1<B2.
